(19) United States
(12) Patent Application Publication
(10) Pub. No.: US 2002/0036165 A1
(43) Pub. Date: Mar. 28, 2002

(54) Filter element for filtering liquid or gaseous media

(76) Inventors: Bruno Sommer, Ludwigsburg (DE); Helmut Luka, Marbach (DE); Ludwig Schott, Loiching (DE)

Correspondence Address: CROWELL & MORING LLP, INTELLECTUAL PROPERTY GROUP, P.O. BOX 14300, WASHINGTON, DC, 20044-4300, US

(21) Appl. No.: 09/948,724

(22) Filed: Sep. 10, 2001

Related U.S. Application Data
(63) Continuation of application No. PCT/EP00/01283, filed on Feb. 17, 2000.

(30) Foreign Application Priority Data
Mar. 9, 1999 (DE) 299 04 204.9

(51) Int. Cl. B01D 27/06; B01D 27/08

(52) U.S. Cl. 210/438; 210/450; 210/493.2

(57) ABSTRACT

A filter element (15) for filtering a liquid or gaseous medium including a pleated filter (16) of paper or non-woven fabric, and end plates (17, 18) on end faces of the filter element, with the end plates preferably being made of thermoplastic synthetic resin material, at least one of the end plates carrying a sealing element (19, 25, 27, 28) which is connected to the end plate by at least two lateral surfaces (20, 21).

### CROSS REFERENCE TO RELATED APPLICATIONS

This application is a continuation of International Application No. PCT/EP00/01283, filed Feb. 17, 2000, designating the United States of America, the disclosure of which is incorporated herein by reference. Priority is claimed based on Federal Republic of Germany patent application no. DE 299 04 204.9, filed Mar. 9, 1999.

### BACKGROUND OF THE INVENTION

The invention relates to a filter element for filtering liquid or gaseous media.

German Patent no. DE 42 25 144 C2 discloses a filter element. This filter element is made, in particular, of a zigzag-shaped folded filter web material, which at its end faces is provided with a plate or foil-type sealing material that is connected to the filter material and covers the same to form a seal. An annular disk of a fusible, deformable material is tightly fused to this sealing material. The annular disk is a nonwoven fabric, which projects radially inwardly or outwardly over the sealing material. A drawback of this arrangement is that the annular disk can assume an undefined configuration relative to the seal. As a result, there is a risk that the nonwoven fabric will become folded or kinked as the filter element is installed in a corresponding housing, so that there is either no filter action at all or the filter action is inadequate.

German Patent no. 44 16 577 discloses a filter element for a filter unit for filtering liquid or gaseous media. This filter element has two end disks, between which a substantially hollow cylindrical filter body made of paper, cotton or felt is arranged. The end disks are injection molded plastic parts made of a thermally disposable synthetic resin material. At least one of the end disks is provided with a central opening by which the filter element can be axially placed onto an inlet or outlet connection for the medium so as to form a seal. To replace the filter element, it can be pulled off the fitting. An annular seal with a rectangular cross section made of a flexible, thermally disposable material is fused or bonded to the end disk and projects over the end disk radially inwardly toward the central opening. The thickness of the seal is selected large enough so that the seal is upset and compressed in its radially inner area after the filter element has been placed onto the fitting. A drawback of this arrangement is that in this form of a seal, very high sealing forces act on the annular seal. This creates gravitational forces between the seal and end disk, which may cause the seal to be detached from the end disk. In addition, the fastening of the annular seal has the result that a reasonably reliable seal is formed between the fitting and the seal only in the immediate vicinity of the contact surface between the end disk and seal. In the area that is remote from the contact surface, only an imperfect or incomplete sealing action can be obtained due to the deformability and yielding of the seal.

### SUMMARY OF THE INVENTION

An object of the invention is to provide a filter element which avoids the aforementioned drawbacks.

Another object of the invention is to provide a filter element which operates reliably and exhibits good sealing quality.

These and other objects are achieved in accordance with the presently claimed invention by providing a filter element for filtering liquid or gaseous media comprising a pleated filter of paper or non-woven fabric, a pair of end plates disposed on end faces of the pleated filter, and a sealing element connected to at least one end plate, wherein the sealing element is connected to the end plate along at least two lateral faces.

In accordance with a further aspect of the invention, the objects are also achieved by providing a filter unit comprising a housing with an inlet opening for supplying an unfiltered medium to be filtered, an outlet opening for discharging filtered medium, a sealing edge arranged on one of the openings, and a filter element according to claim 1, arranged in the housing such that the sealing element on the filter element interacts with the sealing edge in such a way that when the filter element is installed in the housing, a tight joint is created between the filter element and the housing to seal an unfiltered fluid space from a filtered fluid space, and wherein compressive forces arising in the sealing element due to the sealing action are supportingly absorbed by the end plate.

A significant advantage of the invention is that the sealing element, which is arranged on at least one end plate, has a joint structure that produces nearly uniform pressure over the entire effective seal length. This makes it possible on the one hand to reduce the effective seal length and on the other hand to achieve a higher seal quality despite lower component costs.

A particularly reliable sealing system is achieved by a further embodiment of the invention in which the sealing element is an insert that is joined to the end disk during production of the end disk by means of an injection molding process. This arrangement moreover substantially reduces the assembly costs. Additional manufacturing steps to produce the filter element can be avoided.

An alternative embodiment of the invention provides that the sealing element is bonded, welded or latched to the end face. This type of assembly can be selected if inserting a sealing element during the injection molding process would involve excessive handling costs.

A further embodiment of the invention provides that the sealing element is arranged inside a chamber of the end disk. It is of course also possible to configure the sealing element as an insert so that it is enclosed by the thermoplastic material during the injection molding process. The resulting chamber can enclose the sealing element on three sides and will prevent the seal from being damaged or detached.

Instead of the arrangement of an insert or subsequent attachment of a sealing element, it is also possible to form the sealing element together with the end plate in a two-component injection molding process. In the two-component injection molding process, the sealing element can be formed, for instance, from an elastomer material or a foamed polyurethane or some other thermoplastic synthetic resin or other resilient plastic material. The advantage of this arrangement is that it requires neither use of an insert nor any subsequent assembly of the sealing element. The two components are produced in a single operation in the injection-molding machine.

In accordance with another embodiment, the filter element is used in a filter unit. The filter unit has a sealing edge in the vicinity of an opening for discharging the filtered medium. This sealing edge interacts with the sealing element in such a way that a tight joint is created between the sealed space and the sealing element when the filter element is installed in the housing. A significant advantage of this embodiment of the filter element is that the compressive forces between the sealing edge and the sealing element are directly transmitted to the end disk, namely again in the form of compressive forces, either without or with only minor gravitational forces. This makes it possible to achieve a very high sealing action.

These and other features of preferred embodiments of the invention, in addition to being set forth in the claims, are also disclosed in the specification and/or the drawings, and the individual features each may be implemented in embodiments of the invention either individually or in the form of subcombinations of two or more features and can be applied to other fields of use and may constitute advantageous, separately protectable constructions for which protection is also claimed.

### BRIEF DESCRIPTION OF THE DRAWINGS

The invention will now be described in further detail with reference to illustrative preferred embodiments shown in the accompanying drawings in which:

FIG. 1 shows a filter unit with a filter element according to the invention;

FIG. 2 is a detail view of another sealing element; and

FIGS. 3, 4 and 5 show additional variants of the sealing elements.

### DETAILED DESCRIPTION OF PREFERRED EMBODIMENTS

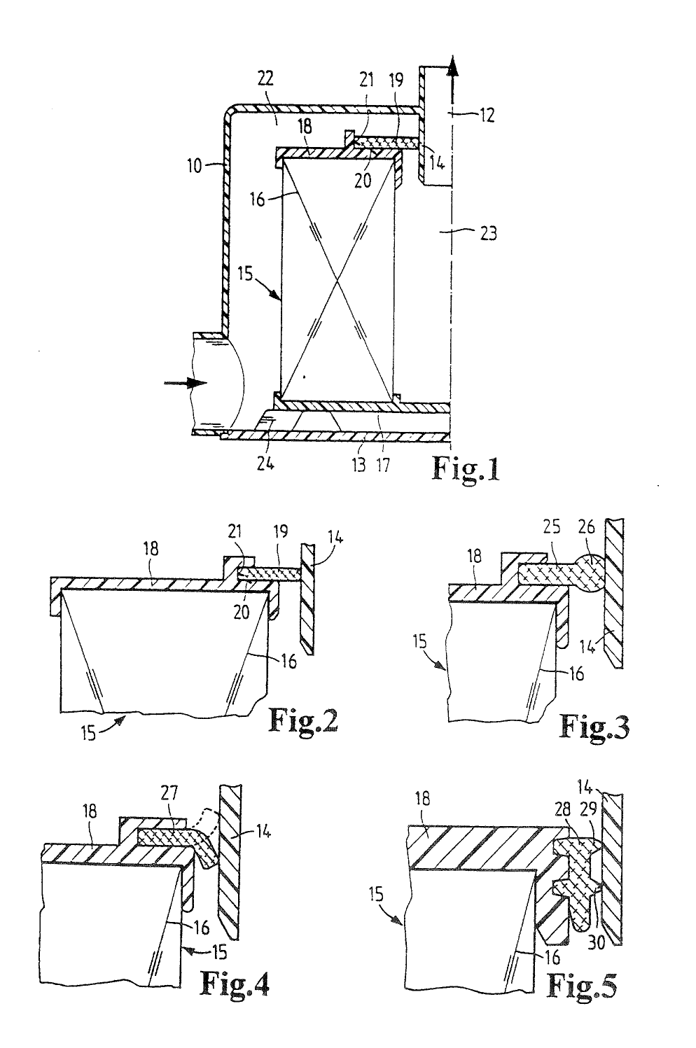

FIG. 1 depicts a housing 10. This housing has an inlet opening 11 for supplying the unfiltered medium and an outlet opening 12 for discharging the filtered medium. The housing is sealed with a cover 13. Opening 12 is provided with a sealing edge 14, which extends inwardly into the housing. A filter element 15 comprised of a pleated, i.e., zigzag-folded, filter paper 16 is arranged within the housing. The filter element 15 is sealed at one end face with an end plate or disk 17 made of a thermoplastic material and at the opposite end face with another end plate or disk 18. End plate 18 carries a sealing element 19. This sealing element 19 is permanently connected with the end plate 18 both along supporting surface 20 and along contact surface 21. The sealing element 19 contacts the sealing edge 14 and thereby seals the unfiltered air zone 22 from the filtered air zone 23 of the air filter depicted in this example. In the area of cover 13, the filter element 15 is secured in position by stabilizers 24, which are arranged in star shape on cover 13. The filter element can of course also be secured in place by any other method. The compressive forces acting in radial direction, which the sealing element 19 must absorb due to the pressure against the sealing edge 14, are essentially transmitted directly to the contact surface 21 and in part also to the support surface 20.

A further refinement of the seat for the sealing element is shown in FIG. 2. Here the seal 19 is enclosed on three sides by end disk plate 18. It goes without saying that this enclosure can absorb very high forces, so that the filter element is highly reliable in operation.

FIG. 3 shows another embodiment of a variation of the sealing element 25. The sealing element 25 is provided with a bead 26 along its end facing the sealing edge 14. Due to the chambering of sealing element 15, the height of the sealing element may be kept small. To optimize the sealing action, the sealing element is provided with a bead-like portion of increased thickness in the sealing area. The advantage of this example is the relatively low material consumption and the low overall height. The low height has the advantage that it contributes to an increase in the effective filter area.

FIG. 4 shows a variant in which the sealing element 27 is again provided with a low height. As a result, when the sealing element is pushed against the sealing edge, it is bent. This bending also creates a relatively long effective seal length without unnecessarily increasing the overall height. The sealing element 27 can bend either inwardly or outwardly (as indicated by the broken line in the drawing). In either case, an effective seal of the filter element along the sealing edge is achieved.

FIG. 5 shows the profile of a sealing element 28, which essentially extends inwardly into the area of the filter element 15. The dual attachment resulting from receiving two mounting ribs in respective chambers on the end plate secures the sealing element 28 against accidental separation. The configuration of two sealing ring beads 29, 30 ensures good sealing action without unnecessarily increasing the mounting or dismounting forces.

Each of the sealing elements shown in the drawings can be produced in a two-component injection molding process when the end plate is produced. It is of course also possible subsequently to arrange the sealing elements on the end plate and secure them by welding or adhesive bonding.

The foregoing description and examples have been set forth merely to illustrate the invention and are not intended to be limiting. Since modifications of the described embodiments incorporating the spirit and substance of the invention may occur to persons skilled in the art, the scope the invention should be construed broadly to include all variations embraced by the appended claims and equivalents thereof.

What is claimed is:

1. A filter element for filtering liquid or gaseous media comprising a pleated filter of paper or non-woven fabric, a pair of end plates disposed on end faces of the pleated filter, and a sealing element connected to at least one end plate, wherein the sealing element is connected to the end plate along at least two lateral faces.

2. A filter element according to claim 1, wherein said end plates are made of thermoplastic synthetic resin material.

3. A filter element according to claim 1, wherein the sealing element comprises an insert, which is joined with the end plate when said end plate is produced in an injection molding process.

4. A filter element according to claim 1, wherein the sealing element is adhesively bonded, welded or mechanically attached to the end plate.

5. A filter element according to claim 1, wherein the sealing element extends into a receiving chamber formed on the end plate.

6. A filter element according to claim 1, wherein the sealing element is manufactured together with the end plate in a two-component injection molding process.

7. A filter unit comprising a housing with an inlet opening for supplying an unfiltered medium to be filtered, an outlet opening for discharging filtered medium, a sealing edge arranged adjacent one of said openings, and a filter element according to claim 1, arranged in said housing such that the sealing element on said filter element interacts with said sealing edge in such a way that when the filter element is installed in the housing, a tight joint is created between the filter element and the housing to seal an unfiltered fluid space from a filtered fluid space, and wherein compressive forces arising in the sealing element due to the sealing action are supportingly absorbed by the end plate.
